(19) United States
(12) Patent Application Publication
(10) Pub. No.: US 2002/0149995 A1
(43) Pub. Date: Oct. 17, 2002

(54) Second embodiment

(76) Inventor: John Stewart Lang, San Pedro, CA (US)

Correspondence Address: JOHN S. LANG, 2209 S. ANCHOVY AV., SAN PEDRO, CA, 90732, US

(21) Appl. No.: 10/161,171

(22) Filed: Jun. 4, 2002

Related U.S. Application Data
(63) Continuation-in-part of application No. 09/399,390, filed on Sep. 20, 1999, now Pat. No. 6,422,735.

(51) Int. Cl. B01F 5/02

(52) U.S. Cl. 366/162.4; 366/175.2

(57) ABSTRACT

A invention mixes chemicals in the form of gases, into a fluid stream. The mixing system withdraws a side stream of fluid from a main fluid stream. The side stream is pressurized and directed through a convergent nozzle, producing a high-velocity jet. This jet is directed onto a deflector plate located on the center line of the conduit that carries the main fluid stream and is thereby diverted in the radial directions normal to the flow direction of the main fluid stream. The deflector is provided with a gas diffusion port for injecting the chemicals that are to be mixed into the main stream. The even distribution of the injected chemicals is ensured by the hydrodynamic forces generated by the flow of the high-velocity jet over the deflector. The invention is a continuation in part of application Ser. No. 09/399,390.

### FIELD OF THE INVENTION

This invention relates to mixing chemicals in a fluid stream and more particularly to hydraulic diffusion flash mixing of chemicals in water treatment and waste water treatment.

### BACKGROUND OF THE INVENTION

This invention is a continuation in part of application Ser. No. 09/399,390, filed on Nov. 20, 1999. As such the general background of this invention is as is stated for the abovementioned Application and is hereby incorporated herein by reference. The PTO ruled that the abovementioned Application contained two embodiments. On Jun. 30, 2000, one embodiment was elected, the embodiment that is shown in FIGS. 2 and 3 of the abovementioned application. A Division of application Ser. No. 09/399,390 was sent to the PTO on May 8, 2002 using Certificate of Mailing Procedure. The second embodiment that is shown in FIGS. 4, 5, 6, and 7 of the abovementioned application is the subject of that division. The claims that pertain to the second embodiment of application Ser. No. 09/399,390 are 38 to 62 inclusive. The abovementioned division renumbered those claims as 1 to 23. Claims 47, and 60 of application Ser. No. 09/399,390 were omitted from the abovementioned division in consideration of the PTO ruling that claims 10, 23, and 35 of application Ser. No. 09/399,390 were not supported by the specification. This application introduces new material in support of claims 47, and 60 of application Ser. No. 09/399,390.

### SUMMARY OF THE INVENTION

The summary of the invention is as appears in application Ser. No. 09/399,390 and is hereby incorporated herein by reference.

### BRIEF DESCRIPTION OF THE DRAWINGS

The brief description of the drawings of the invention is as appears in application Ser. No. 09/399,390 and is hereby incorporated herein by reference. An additional drawing, herein numbered FIG. 10, is included in support of claims 47, and 60.

FIG. 10 is an illustration of a deflector that could be used with the second embodiment of the invention and that would produce a fluid jet stream that is deflected in an unsymmetrical pattern.

### DETAILED DESCRIPTION OF THE PREFERRED EMBODIMENT

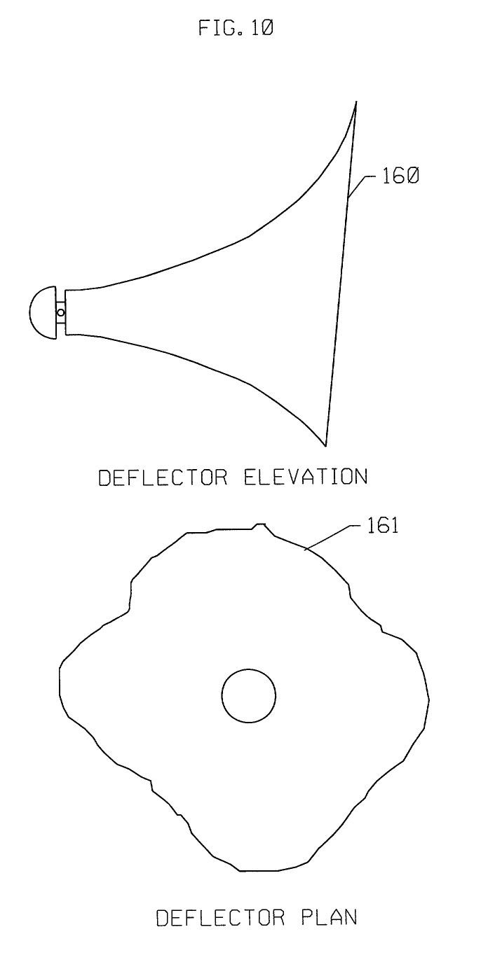

The detailed description of the preferred embodiments is as appears in application Ser. No. 09/399,390 and is hereby incorporated herein by reference. New material is inserted after the sentence ending “ . . . according to the invention.” on line 25 of page 11 of application Ser. No. 09/399,390. VIZ This topological transformation may produce a deflector with an unsymmetrical shape, as shown in FIG. 10. The unsymmetrical deflector can be classified as a cone according to the mathematical definition of a cone, “A solid bounded by a region enclosed in a closed curve on a plane and a surface formed by the segments joining each point of the closed curve to a point not in the plane.”, Dictionary of Scientific and Technical Terms, Second Edition, McGraw Hill Inc., NYC, 1978, p 344. FIG. 10 shows such a deflector. In FIG. 10, the cone's base plane 160, is shown to be at an arbitrary angle to the cone's longitudinal axis; and the closed curve 161, located on the base plane 160, is unsymmetrical.

### OPERATION OF THE INVENTION

The operation of the invention is as appears in application Ser. No. 09/399,390 and is hereby incorporated herein by reference. New material is inserted after the sentence ending “ . . . taken along line 5-5 of FIG. 1.” on line 12 of page 12 of application Ser. No. 09/399,390. VIZ In general the jet pattern will be radially symmetric. However, if an unsymmetrical deflector, such as the deflector illustrated in FIG. 10, were to be used, the jet pattern will be unsymmetrical.

The foregoing disclosure and drawings are merely illustrative of this invention and are not to be interpreted in a limiting sense. The invention is described by the claims.

We claim:

47. The apparatus of claim 42, wherein the deflector has a shape such that the fluid jet steam is deflected in an unsymmetrical pattern.

60. The apparatus of claim 55, wherein the deflector has a shape such that the fluid jet steam is deflected in an unsymmetrical pattern.
